(19) United States
(12) Patent Application Publication
(10) Pub. No.: US 2026/0301207 A1
(43) Pub. Date: Oct. 1, 2026

(54) ROBUST IMAGE-BASED THREE-DIMENSIONAL SENSING TECHNIQUES

(71) Applicant: Hong Kong Applied Science and Technology Research Institute Co., Ltd., Shatin (HK)

(72) Inventors: Ka Yiu Wong, Shatin (HK); Ziyi Lin, Shatin (HK); Haoen Huang, Shatin (HK); Yan Zhang, Shatin (HK)

(21) Appl. No.: 19/092,791

(22) Filed: Mar. 27, 2025

(51) Int. Cl. G06T 7/593; G06T 7/10; G06T 7/73; G06T 7/90; G06T 17/20

(52) U.S. Cl. CPC G06T 7/593; G06T 7/10; G06T 7/74; G06T 7/90; G06T 17/20; G06T 2207/10021; G06T 2207/10024; G06T 2207/20081; G06T 2207/20084; G06T 2207/20092; G06T 2207/30241; G06T 2210/12; G06T 2210/56

(57) ABSTRACT

This disclosure provides systems, methods, and devices that facilitate image-based three-dimensional (3D) scanning and reconstruction of an object. In one aspect, a method is provided that includes capturing, by a computing device, multiple images of the object from various viewpoints. The method further includes detecting a region containing the object in each image, extracting visual features within that region, and generating segmentation masks using these features. A first machine learning model determines a volumetric 3D representation of the object based on the images and masks; a second representation is then derived, such as a mesh or point cloud. Additional processes include pose estimation for known objects and stereo-based depth prediction for transparent and opaque materials. Other aspects are provided.

### BACKGROUND

Three-dimensional sensing has found widespread adoption in fields such as robotics, virtual and augmented reality, industrial automation, and healthcare, among others. By collecting spatial information about objects or environments, 3D sensing technologies enable more immersive user experiences, improve automated processes, and support detailed analyses of physical scenes. Various capture techniques, including stereo imaging, structured light scanning, and time-of-flight measurements, can be applied to obtain geometric and volumetric data. This data may then be used for purposes such as object modeling, collision detection, digital content creation, and real-time mapping, illustrating the broad impact and versatility of three-dimensional sensing.

### SUMMARY

The present techniques provide an image-based 3D sensing system compatible with consumer-level devices, such as smartphones and tablets equipped with single or dual camera modules. The system enables effective 3D scanning, pose estimation, and surface reconstruction of objects with both transparent and opaque surfaces. By utilizing text prompts for initial object detection and advanced machine learning models for segmentation and depth estimation, the system addresses the challenges associated with reconstructing objects, and especially transparent objects, using conventional methods. The techniques include capturing multi-view images, generating segmentation masks based on visual features, creating three-dimensional representations using neural networks, and generating refined depth maps through recursive feature matching.

In a first aspect, a method includes capturing, by a first computing device, a plurality of images of an object from a plurality of viewpoints; determining, for each respective image of at least a subset of the plurality of images, a respective first region that contains the object; determining, for each respective image of the at least the subset, a plurality of visual features of the object within the respective first region; determining, for each respective image of the at least the subset, a segmentation mask of the object based on the plurality of visual features; determining, using a first machine learning model, a first three-dimensional representation of the object based on the plurality of images and the segmentation masks; and determining a second three-dimensional representation of the object based on the first three-dimensional representation.

In a second aspect according to the first aspect, the method further includes training the first machine learning model based on the plurality of images and the segmentation masks prior to determining the first three-dimensional representation.

In a third aspect according to any one of the first through second aspects, the method is such that the first three-dimensional representation includes one or more parameters representing estimated volumetric data of the object, the second three-dimensional representation includes a plurality of three-dimensional coordinates defining a surface of the object, or a combination thereof.

In a fourth aspect according to any one of the first through third aspects, the first machine learning model is configured to determine signed distance function values and red-green-blue (RGB) color values based on the plurality of images and the segmentation masks.

In a fifth aspect according to the fourth aspect, generating the second three-dimensional representation includes converting the signed distance function values and RGB color values into a three-dimensional point cloud and mesh model.

In a sixth aspect according to any one of the first through fifth aspects, the method is such that capturing the plurality of images includes extracting the plurality of images from a video captured by the first computing device that contains the object.

In a seventh aspect according to any one of the first through sixth aspects, determining the respective first region of each respective image includes determining a bounding box around the object in each respective image based on a text input received from a user.

In an eighth aspect according to the seventh aspect, the text input specifies one or more characteristics of the object.

In a ninth aspect according to any one of the seventh and eighth aspects, determining the bounding box around the object includes applying an object detection model configured to detect objects corresponding to the text input within the plurality of images.

In a tenth aspect according to any one of the first through ninth aspects, the method further includes correlating the plurality of visual features across the at least the subset of the plurality of images to identify corresponding features.

In an eleventh aspect according to the tenth aspect, capturing the plurality of images further includes recording trajectory data corresponding to each image, the trajectory data indicating a position and/or an orientation of the first computing device when capturing the respective image, wherein correlating the plurality of visual features is performed at least in part based on the trajectory data.

In a twelfth aspect according to any one of the first through eleventh aspects, the object includes at least a transparent material.

In a thirteenth aspect according to any one of the first through twelfth aspects, the method further includes determining, for each respective image of the at least the subset of the plurality of images, a respective pose of the object in the respective image.

In a fourteenth aspect according to the thirteenth aspect, determining the respective pose of the object includes constructing a reference database for the object based on the plurality of images, wherein the reference database includes semantic representations of the object, rotation-aware encodings of the object, or a combination thereof; identifying, for each respective image, a corresponding reference representation within the reference database; and determining the respective pose of the object in each respective image based on the corresponding reference representation.

In a fifteenth aspect according to the fourteenth aspect, constructing the reference database further includes selecting, using farthest point sampling, one or more keyframes from the plurality of images; determining, using a deep neural network, feature tokens from the one or more keyframes; determining, using a transformer-based module and a mask decoder, segmentation masks for the object based on the feature tokens; determining object-aware semantic tokens based on the feature tokens and the segmentation masks; and determining, using a rotation-aware encoder model, image-level embedding vectors representing rotation-aware features of the object based on the object-aware semantic tokens.

In a sixteenth aspect according to the fifteenth aspect, identifying the corresponding reference representation for each respective image includes extracting a semantic representation and rotation-aware features of the object from the respective image; comparing the extracted semantic representation and rotation-aware features with the reference database to identify the corresponding reference representation; and determining an initial pose of the object in the respective image based on the corresponding reference representation.

In a seventeenth aspect according to any one of the first through sixteenth aspects, capturing the plurality of images includes using a dual-camera module to capture stereo image pairs.

In an eighteenth aspect according to the seventeenth aspect, the method further includes processing the stereo image pairs using a third machine learning model to generate a depth map, wherein processing the stereo image pairs includes extracting features from the stereo image pairs; providing the features to the third machine learning model to perform recursive feature matching and depth estimation; and determining a refined depth map representing both transparent and opaque materials present in the scene based on the depth estimation.

In a nineteenth aspect according to the eighteenth aspect, the third machine learning model is trained using a synthetic dataset including a plurality of randomly generated models, materials, lighting conditions, camera settings, and environmental effects.

In a twentieth aspect, a system includes a processor and a memory storing instructions which, when executed by the processor, cause the processor to perform operations including capturing a plurality of images of an object from a plurality of viewpoints; determining, for each respective image of at least a subset of the plurality of images, a respective first region that contains the object; determining, for each respective image of the at least the subset, a plurality of visual features of the object within the respective first region; determining, for each respective image of the at least the subset, a segmentation mask of the object based on the plurality of visual features; determining, using a first machine learning model, a first three-dimensional representation of the object based on the plurality of images and the segmentation masks; and determining a second three-dimensional representation of the object based on the first three-dimensional representation.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system for image-based three-dimensional sensing according to one aspect of the present disclosure.

FIG. 2A illustrates a processing flow for three-dimensional scanning according to one aspect of the present disclosure.

FIG. 2B illustrates a processing flow for pose estimation according to one aspect of the present disclosure.

FIG. 2C illustrates a processing flow for depth map determination according to one aspect of the present disclosure.

FIG. 3 illustrates a method for image-based three-dimensional sensing according to one aspect of the present disclosure.

FIG. 4 illustrates a computing system according to one aspect of the present disclosure.

### DETAILED DESCRIPTION OF EXAMPLE EMBODIMENTS

Traditional 3D sensing methods, such as active stereo vision, LiDAR, laser scanning, and structured light, rely on capturing reflected or emitted light from objects to reconstruct their three-dimensional geometry. While these methods work effectively for opaque objects, they encounter significant difficulties when dealing with transparent materials like glass, plastic, and certain liquids. Transparent objects refract and transmit light in ways that confuse conventional sensors, leading to inaccurate or incomplete 3D models.

Existing sensors often fail to capture sufficient data for accurate modeling of transparent objects due to their minimal reflection of projection light. This limitation poses challenges in various applications where transparent objects are prevalent, such as manufacturing (quality control of glass products), robotics (manipulation of transparent items), augmented reality (accurate overlay in environments with transparent surfaces), and healthcare (imaging of medical devices in transparent vessels). Current techniques either ignore transparent objects or require expensive, specialized equipment unsuitable for consumer-level applications, limiting their accessibility and practicality.

One solution to this problem is to develop an image-based 3D sensing system that leverages consumer-grade devices equipped with standard camera modules. The present techniques utilize multi-view image capture and user-provided text prompts to perform initial object detection, enabling the system to focus on the object of interest even in complex scenes. By estimating visual features within the detected regions and generating segmentation masks through prompt-based segmentation, the system accurately isolates the object in each frame.

Advanced machine learning models are employed to reconstruct three-dimensional representations of the object from the segmented images. The techniques include training neural networks to determine signed distance function (SDF) values and RGB color values, facilitating the creation of detailed volumetric and surface models.

For pose estimation, the system may construct a reference database containing semantic representations and rotation-aware encodings of known objects. By extracting features from the captured images and matching them with the reference database, the system can accurately determine the object's position and orientation in new images. Techniques such as rotation-aware feature encoding enable robust pose estimation even when the object appears in different orientations, enhancing applications like robotic manipulation and augmented reality.

Additionally, the system may generate refined depth maps using stereo images and recursive feature matching, improving depth estimation accuracy for both transparent and opaque materials. By processing features at multiple downsampled scales and employing a recurrent neural network, the techniques achieve precise depth estimation, which is particularly challenging for transparent objects due to their refractive properties. This surface reconstruction approach improves the accuracy and speed of depth estimation and facilitates accurate and prompt interaction within virtual environments.

In some aspects, the present disclosure provides techniques for image-based 3D sensing of transparent objects that may be particularly beneficial in applications requiring accurate and accessible 3D reconstruction without specialized equipment. For example, by leveraging standard camera modules in consumer devices, these techniques enable cost-effective and accurate scanning of transparent materials, expanding the capabilities of devices like smartphones and tablets.

By incorporating pose estimation methods that utilize reference databases and rotation-aware encodings, the techniques may improve the accuracy of determining an object's position and orientation across different viewpoints. This enhancement is beneficial for applications such as robotics, where precise object handling is crucial, and in augmented reality, where virtual objects need to align accurately with real-world counterparts.

The surface reconstruction methods employing recursive feature matching and depth estimation may improve the depth accuracy for both transparent and opaque materials. This advancement enables more detailed and reliable 3D models, which enhances user experiences in applications like robotic manipulation tasks, virtual reality, and architectural visualization. Users can perform 3D surface reconstructions of complex scenes without the need for expensive sensors or complex setups.

Additionally, the techniques enhance the functioning of computing devices by employing efficient machine learning models and algorithms optimized for consumer hardware, ensuring practical performance levels without sacrificing accuracy or quality. By utilizing strategies like multi-scale feature extraction and recurrent neural networks, the system maintains high accuracy while operating efficiently on standard devices.

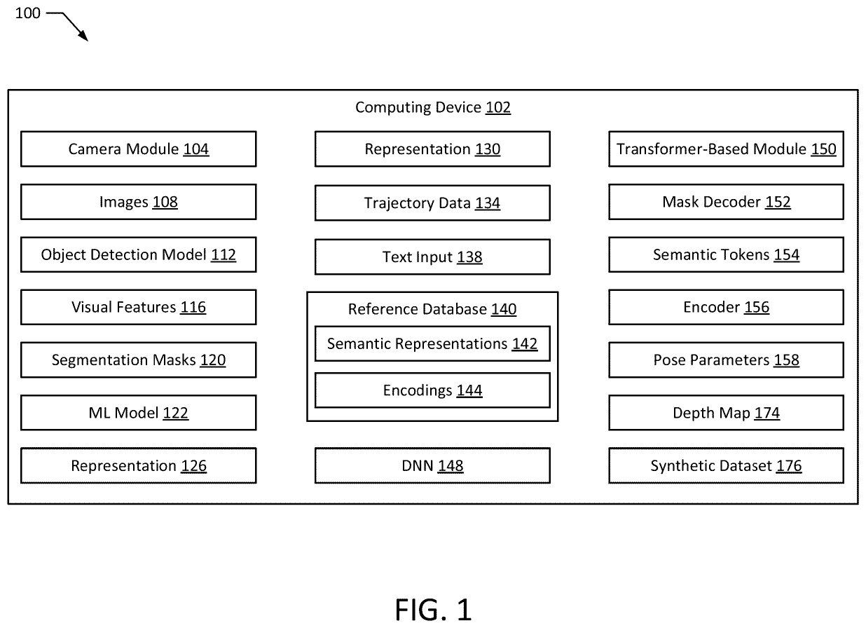

FIG. 1 depicts a system 100 for image-based three-dimensional sensing according to one aspect of the present disclosure. The system 100 includes a first computing device 102. The computing device 102 includes a camera module 104, images 108, an object detection model 112, and visual features 116. The computing device 102 further includes segmentation masks 120, a first machine learning model 122, a first three-dimensional representation 126, and a second three-dimensional representation 130. The computing device 102 also includes trajectory data 134, a text input 138, and a reference database 140. The reference database 140 includes semantic representations 142 and rotation-aware encodings 144. The computing device 102 further includes a deep neural network 148, a transformer-based module 150, a mask decoder 152, object-aware semantic tokens 154, a rotation-aware encoder 156, pose parameters 158, a depth map 174, and a synthetic dataset 176.

In certain implementations, a first computing device 102 may capture a plurality of images 108 of an object from a plurality of viewpoints. The first computing device 102 may be a consumer device such as a smartphone or a tablet, which provides accessibility and ease of use for users engaging in three-dimensional (3D) scanning tasks. The plurality of images 108 may be extracted from a video captured by the first computing device 102 that contains the object of interest. For example, the first computing device 102 may record a video of a transparent bottle placed on a table. The video may capture views covering approximately 360 degrees around the bottle. In certain implementations, the video may exclude views of the bottom surface that rests on the table. To achieve near-complete coverage, the user may move the first computing device 102 around the object in a circular path while maintaining a consistent distance. The camera module 104 of the first computing device 102 may record the video at high resolution, such as 1080p or higher, and at a frame rate of 30 or 60 frames per second to ensure image clarity.

The plurality of images 108 may be extracted from the recorded video by selecting individual frames that meet certain quality criteria. Methods for ensuring image quality may include analyzing frames for motion blur, sharpness, and exposure levels. The system may select frames at regular intervals or based on significant changes in viewpoint to maximize the diversity of perspectives. Techniques for synchronizing the extracted images 108 with corresponding viewpoint data may involve recording the position and orientation of the first computing device 102 at the time each frame is captured, potentially using sensor data such as gyroscope or accelerometer readings.

To ensure comprehensive coverage of the object from different viewpoints, the first computing device 102 may provide guided capture instructions to the user. For instance, the device may display prompts advising the user to move around the object in a steady motion or to cover specific angles not yet captured. Environmental factors affecting image capture, such as lighting conditions and background contrast, may also be considered. For example, the computing device 102 may display instructions to ensure adequate ambient lighting to minimize shadows and highlights on the object, and to use a plain background to enhance object distinction in the images 108.

In certain implementations, capturing the plurality of images 108 may further include recording trajectory data 134 corresponding to each image. The trajectory data 134 may indicate the position and/or orientation of the first computing device 102 when capturing each respective image. The trajectory data 134 may be captured through device sensors such as gyroscopes, accelerometers, magnetometers, or through visual odometry techniques. Device sensors can provide information about the device's movement and orientation in physical space. For example, a gyroscope measures the rate of rotation around the device's axes, while an accelerometer measures linear acceleration. By integrating this sensor data over time, the first computing device 102 can estimate its trajectory during the image capture process. Visual odometry involves analyzing the captured images 108 themselves to estimate the movement of the first computing device 102 between frames. By tracking visual features 116 across sequential images and calculating the relative motion, the device can infer its trajectory without relying on additional sensors. In some cases, sensor data and visual odometry may be combined to improve accuracy.

For each respective image of at least a subset of the plurality of images 108, the first computing device 102 may determine a respective first region that contains the object. To determine the first region, the computing device 102 may be configured to to determine a bounding box around the object in each respective image of the plurality of images 108. The first region may be determined based on a text input 138 received from a user. The text input 138 may include any user-provided textual description that specifies characteristics of the object to be detected. For example, the user may input “transparent bottle” or “transparent glass vase” to assist the system in identifying the object within the images 108. The text input 138 may specify one or more characteristics of the object, such as color, shape, size, or material.

To determine the first region, the first computing device 102 may apply an object detection model 112 configured to detect objects corresponding to the text input 138 within the plurality of images 108. The object detection model 112 may be a machine learning model based on algorithms such as You Only Look Once (YOLO) or Single Shot MultiBox Detector (SSD). These models are trained to identify and locate objects within images by learning features associated with various object classes. In certain implementations, the object detection model 112 may be trained using a dataset that pairs images with textual descriptions, allowing the model to associate text inputs with visual features. During training, the model 112 learns to recognize patterns and features corresponding to specific object characteristics.

Before applying the object detection model 112, preprocessing steps may be applied to the images 108 to enhance detection accuracy. These steps may include resizing images to a standard resolution, normalizing pixel values, and/or performing noise reduction techniques to eliminate artifacts. The computing device 102 may be configured to handle multiple objects in the scene by utilizing the text input 138 to focus on the object of interest. If multiple objects match the description, the computing device 102 may prompt the user for additional characteristics or select the most prominent object.

In certain implementations, the computing device 102 may utilize natural language processing techniques to interpret complex or varied user inputs in the text input 138. For instance, the computing device 102 may employ techniques such as tokenization, part-of-speech tagging, and dependency parsing to analyze the text input 138. Tokenization involves breaking down the input text into individual words or tokens. Part-of-speech tagging assigns grammatical categories to each token, such as nouns, adjectives, or verbs. Dependency parsing determines the grammatical structure of the sentence by identifying relationships between words. If the user specifies “small blue vase with floral patterns,” the system may tokenize the input into [“small”, “blue”, “vase”, “with”, “floral”, “patterns”], perform part-of-speech tagging to identify descriptors and objects, and use dependency parsing to understand that “small” and “blue” describe the “vase,” which has “floral patterns.” This allows the system to extract relevant characteristics such as size (“small”), color (“blue”), and patterns (“floral”). The system may handle ambiguous or conflicting characteristics by implementing word sense disambiguation or context-aware models to prioritize certain attributes based on the overall input. In cases of ambiguity, the computing device 102 may request clarification from the user to ensure accurate object detection.

1. In certain implementations, the first computing device 102 may determine, for each respective image of at least a subset of the plurality of images 108, a plurality of visual features 116 of the object within the respective first region. The visual features 116 may include distinctive patterns or key points within the object that are detectable and trackable across multiple images. Examples of visual features 116 include edges, corners, blobs, ridges, textures, and scale-invariant features that can be reliably identified under varying imaging conditions. For instance, the corner of a table, the intersection point of two edges on a box, or a distinct pattern on a textured surface may serve as key points. These features are significant in representing the object's unique characteristics and are essential for subsequent processing steps such as segmentation and 3D reconstruction. The key points may be selected based on stability and repeatability measures across different viewpoints and lighting conditions. For instance, corners, edges, and blobs within the object may serve as key points because they exhibit significant gradients in pixel intensity. The significance of these key points lies in their ability to capture the object's structural and textural details, which are critical for accurately identifying and matching features across images. In certain implementations, the first computing device 102 may overlay the detected key points on the object within the images 108 to visualize their distribution and density.

To detect the key points within the respective first region, the first computing device 102 may employ algorithms for key point detection such as the Scale-Invariant Feature Transform (SIFT), Speeded-Up Robust Features (SURF), Oriented FAST and Rotated BRIEF (ORB), and the like. For example, SIFT may detect key points by identifying locations in the image where variations in pixel intensity occur across scales and orientations. SURF may provide a faster alternative by approximating Gaussian kernels with box filters, making it suitable for real-time applications. ORB may combine the FAST key point detector and the BRIEF descriptor, offering efficient computation and good performance in feature matching.

Detecting key points on objects with low texture or uniform surfaces, such as a plain glass vase, may present challenges due to the lack of distinctive features. In such cases, the first computing device 102 may enhance feature detection by incorporating additional methods like adding artificial texture (e.g., projecting a pattern onto the object) or adjusting imaging conditions to reveal subtle surface details.

The visual features 116, including key points and their descriptors, may be stored and managed for subsequent processing steps. The first computing device 102 may organize the visual features 116 in data structures such as feature maps or descriptor matrices, facilitating efficient retrieval and comparison. For example, each key point may be associated with its coordinates, scale, orientation, and descriptor vector.

To handle scale and rotation variations in the object during feature detection, the first computing device 102 may employ scale-space representation and orientation assignment techniques. In scale-space representation, key points may be detected at multiple scales by progressively smoothing the image and identifying features that persist across scales. Orientation assignment involves computing the dominant gradient direction around a key point, enabling the descriptors to be rotation-invariant. These strategies may improve consistency of the detected visual features 116 despite changes in viewpoint or object orientation.

In certain implementations, the first computing device 102 may further correlate the plurality of visual features 116 across at least a subset of the plurality of images 108 to identify corresponding features. Correlating visual features refers to the process of matching key points or descriptors from different images to determine which features represent the same physical points on the object. Identifying corresponding features across images is essential for reconstructing the object's three-dimensional structure and for estimating the spatial relationships between viewpoints. To perform feature matching across images, the first computing device 102 may employ algorithms such as brute-force matching or the Fast Library for Approximate Nearest Neighbors (FLANN) based matcher. Brute-force matching involves comparing each descriptor from one image with all descriptors from another image to find the best match based on a distance metric, such as Euclidean distance or Hamming distance for binary descriptors. After initial correspondences are established, the first computing device 102 may filter the matched features to remove outliers and improve reliability. For example, Robust Estimation techniques such as the Random Sample Consensus (RANSAC) algorithm may be applied.

When correlating the plurality of visual features 116, the first computing device 102 may perform the correlation at least in part based on the trajectory data 134. Fusion techniques that combine visual features and trajectory data enable robust matching, especially in challenging conditions where feature detection alone may be insufficient. For example, the computing device 102 may use the estimated poses from the trajectory data to apply geometric constraints during matching, such as the epipolar constraint in stereo vision, which states that corresponding points must lie along specific lines in each image. In certain implementations, one or more pose estimation techniques that utilize both visual features and trajectory data may be used, such as bundle adjustment and Simultaneous Localization and Mapping (SLAM).

In certain implementations, the first computing device 102 may determine, for each respective image of at least a subset of the plurality of images 108, a segmentation mask 120 of the object based on the plurality of visual features 116. The segmentation mask 120 may refer to a binary or probabilistic map indicating the pixels in the image that belong to the object. To generate the segmentation mask 120, the first computing device 102 may use a second machine learning model configured for prompt-based segmentation. Prompt-based segmentation may include guiding the segmentation process using external inputs or prompts, such as the visual features 116 and possibly the text input 138 provided by the user. The prompts may serve as additional information to focus the model's attention on specific areas of the image. For instance, the model may use the key points detected earlier to delineate the object's boundaries more accurately. The second machine learning model may integrate the visual features 116 by incorporating them into the model's input channels or by using attention mechanisms that highlight regions around the key points. Additionally, the text input 138 specifying object characteristics may be embedded and fed into the model to influence segmentation decisions. By combining visual cues with textual descriptions, the model can achieve more precise segmentation, especially in complex scenes.

The training process of the second machine learning model may include using datasets that include images with corresponding segmentation masks and associated prompts. For example, the model may be trained on datasets like COCO, PASCAL VOC, or custom datasets containing annotated objects. During training, data augmentation techniques like rotation, scaling, and flipping may be applied to increase the diversity of the training data and improve the model's robustness to variations. The loss function may include components like binary cross-entropy for pixel-wise classification and IoU (Intersection over Union) loss to enhance mask accuracy. For example, if the object is a transparent glass vase, the model may learn to identify subtle edges and reflections characteristic of transparent materials.

Post-processing steps may be applied to improve segmentation accuracy further. For instance, conditional random fields (CRFs) may be used to refine the segmentation masks 120 by considering the spatial and color consistency of neighboring pixels. CRFs may help in smoothing the masks while preserving sharp edges, leading to more precise object delineation. As another example, the segmentation masks 120 may be refined or validated using techniques like morphological operations or consistency checks. Morphological operations such as erosion and dilation may be applied to remove small artifacts or to close gaps in the mask. Consistency checks may involve verifying that the mask aligns with the detected key points and that the object's expected shape and size are maintained across images.

In certain implementations, the first computing device 102 may determine, using a first machine learning model 122, a first three-dimensional representation 126 of the object based on the plurality of images 108 and the segmentation masks 120. In certain implementations, the first three-dimensional representation 126 may refer to a volumetric depiction of the object, capturing its shape and internal structure as estimated from the two-dimensional images and segmentation data. For example, the first three-dimensional representation 126 may include parameters representing estimated volumetric data of the object, such as SDF values across a spatial grid.

In certain implementations, the first machine learning model 122 may be a neural network configured for processing spatial data. In certain implementations, the neural network may employ a multi-layer perceptron (MLP) architecture with skip connections to facilitate the learning of complex functions. In certain implementations, the first machine learning model 122 may be trained based on the plurality of images 108 and the segmentation masks 120. Training the first machine learning model 122 involves optimizing the model's parameters to accurately reconstruct the three-dimensional representation 126 from input data. The training process may utilize loss functions that measure the difference between the model's predictions and the ground truth data, guiding the optimization process. For example, the loss functions may include a combination of reconstruction loss and regularization terms. The reconstruction loss may quantify the discrepancy between the predicted volumetric data and the actual object shape, potentially using metrics like mean squared error (MSE). Regularization terms may be added to prevent overfitting and encourage smoothness in the reconstructed model. The training dataset for the first machine learning model 122 may consist of the captured images 108 and corresponding segmentation masks 120 of various objects under different conditions. The dataset may be divided into batches to facilitate efficient training, with each batch containing a subset of the data. Training may proceed for multiple epochs, where an epoch refers to a full pass through the entire training dataset. Data augmentation techniques such as random rotations, scaling, and color jittering may be applied to enhance the diversity of the training data and improve the model's generalization to unseen data.

In certain implementations, the first machine learning model 122 may be trained specifically on the captured images 108 and the corresponding segmentation masks 120 obtained during the current scanning process. This on-the-fly training allows the model to adapt to the specific object and capture conditions, enhancing the accuracy of the reconstruction. In such instances, training the first machine learning model 122 involves optimizing the model's parameters to accurately reconstruct the three-dimensional representation 126 from the input data. Given that the training occurs with the actual images 108 captured during the scanning session, the dataset may be limited in size. To address this, the first computing device 102 may employ techniques such as transfer learning or fine-tuning from a pre-trained model to effectively learn from the available data. The dataset may be augmented by applying transformations like random rotations, scaling, and color jittering to increase diversity. Training may proceed for a sufficient number of epochs to ensure convergence, balancing computational efficiency with model performance. By training on the specific object data, the first machine learning model 122 can learn object-specific features and improve the fidelity of the three-dimensional representation 126.

The first machine learning model 122 learns to reconstruct the three-dimensional representation 126 by identifying patterns and correlations between the two-dimensional input and the three-dimensional structure. By processing multiple views of the object along with accurate segmentation, the model can infer depth and volumetric information that is not directly observable from a single viewpoint. In certain implementations, the first machine learning model 122 may be configured to determine signed distance function (SDF) values and red-green-blue (RGB) color values based on the plurality of images 108 and the segmentation masks 120. Signed distance functions may represent a shape implicitly by the distance of any point in space to the nearest surface of the object. An SDF value at a point is negative if the point is inside the object, zero if on the surface, and positive if outside. The model 122 may be configured to estimate SDF values for the object by predicting the distance of points within a defined volume to the object's surface, effectively capturing the object's geometry in a continuous manner. This representation may allow for high-resolution detail without the need for explicit mesh topology during the initial reconstruction phase. The RGB color values may be associated with the volumetric representation to capture the object's appearance, including texture and material properties.

In certain implementations, the first computing device 102 may determine a second three-dimensional representation 130 of the object based on the first three-dimensional representation 126. The second three-dimensional representation 130 may refer to a more tangible depiction of the object's surface, derived from the volumetric data of the first representation. For example, the second three-dimensional representation 130 may include a plurality of three-dimensional coordinates defining a surface of the object, effectively converting the volumetric data into a surface mesh or point cloud.

To extract the surface from the volumetric data, the first computing device 102 may utilize algorithms such as the marching cubes algorithm. The marching cubes algorithm systematically processes the volumetric grid to identify iso-surfaces at a specified threshold (usually where the SDF value is zero, indicating the object's surface). By interpolating between grid points, the algorithm constructs a mesh composed of vertices, edges, and faces that approximates the object's surface.

The surface may be represented represented using data structures suitable for rendering and analysis. For example, point clouds may store the three-dimensional coordinates of points on the object's surface, while mesh models may include vertices, edges, and faces defining the topology of the surface. As another example, surface normals, representing the orientation of the surface at each point, may be calculated by computing the gradient of the SDF at each vertex. As a further example, texture coordinates, mapping points on the surface to locations in texture space (e.g., the original images), may also be determined for applying color and texture information.

In certain implementations, determining the second three-dimensional representation 130 may involve converting the SDF values and RGB color values into a three-dimensional point cloud and mesh model. The first computing device 102 may perform a threshold analysis of the SDF values to identify the surface boundary and use iso-surface extraction methods to generate the mesh. The computing device 102 may additionally or alternatively map the RGB color values onto the mesh by associating each vertex with the corresponding color information from the input images, resulting in a textured 3D model. For example, the first computing device 102 may project the color data from the images 108 onto the mesh by establishing correspondences between image pixels and mesh vertices based on the camera parameters and the known viewpoints. Visual examples of the final 3D models with textures applied may include the reconstructed transparent bottle exhibiting realistic refractive and reflective properties, or the transparent glass vase exhibiting realistic reflectance properties.

To improve visual quality, the first computing device 102 may apply smoothing or mesh optimization techniques. Smoothing algorithms like Laplacian smoothing may reduce noise and irregularities on the mesh surface. Mesh optimization may involve simplifying the mesh by reducing the number of polygons while preserving important geometric features, facilitating efficient rendering and storage.

The second three-dimensional representation 130 may be used in various applications such as rendering, simulation, or 3D printing. For rendering, the textured mesh can be imported into graphical software for visualization or inclusion in virtual environments. In simulation, the accurate geometry and texture enable realistic interactions in physics-based models. For 3D printing, the mesh can be converted into formats compatible with additive manufacturing processes. The first computing device 102 may store the 3D models using various file formats or data serialization methods suitable for three-dimensional data, such as OBJ, PLY, or STL files, which store geometry, color, and texture information.

In certain implementations, the method may further handle multiple objects by repeating the determining and generating steps for each object individually. Detecting and isolating multiple objects in images may include identifying and processing each object separately to construct their respective three-dimensional representations. In certain implementations, to detect multiple objects, the computing device 102 may be configured to apply object detection models that recognize and localize all objects of interest within the images 108. The first computing device 102 may use models like YOLO or SSD, configured to detect multiple classes or instances simultaneously. Once the objects are detected, segmentation masks 120 and visual features 116 may be generated for each object individually. For example, if a scene includes several items placed on a table, such as a transparent bottle, a blue water bottle, and a green apple, the first computing device 102 may detect each object based on user-provided text inputs or predefined classes. The device 102 may then proceed to individually extract visual features, generate segmentation masks, and reconstruct three-dimensional representations for each object.

In certain implementations, the first computing device 102 may determine, for each respective image of at least a subset of the plurality of images 108, a respective pose of the object in the respective image. The pose of the object may refer to its position and orientation in space relative to the camera or a global coordinate system.

In certain implementations, determining the respective pose of the object may include constructing a reference database 140 for the object based on the plurality of images 108. The reference database 140 may include semantic representations 142 of the object, rotation-aware encodings 144 of the object, or a combination thereof. The semantic representations 142 may refer to feature vectors capturing the object's appearance and attributes, while the rotation-aware encodings 144 may capture information about the object's orientation. The semantic representations 142 may be high-dimensional feature vectors derived from the object's visual characteristics, such as texture, shape, and color. The rotation-aware encodings 144 may include embeddings that capture the object's appearance relative to different orientations, enabling the system to recognize the object regardless of how it is rotated in the image.

In certain implementations, constructing the reference database 140 may include selecting, using farthest point sampling, one or more keyframes from the plurality of images 108. Farthest point sampling may be used to select a representative subset of data points that are maximally distant from each other in the feature space.

In certain implementations, when constructing the reference database 140, the first computing device 102 may determine, using a deep neural network 148, feature tokens from the one or more keyframes. Feature tokens may refer to compact and descriptive representations of local or global features extracted from the images. The deep neural network 148 may process the keyframes to extract these tokens, capturing essential information about the object's appearance. The deep neural network 148 feature extraction may be a convolutional neural network (CNN) with layers configured to capture both low-level and high-level features from the images. The network may include convolutional layers, pooling layers, and activation functions such as ReLU to introduce non-linearity.

In certain implementations, the feature tokens may be processed with a transformer-based module 150 and a mask decoder 152 to generate segmentation masks 120 for the object based on the feature tokens. Transformer-based modules 150 may include architectures that utilize self-attention mechanisms to model relationships within sequential data, allowing the network to capture context and dependencies across the image. The mask decoder 152 may translate the encoded features into pixel-wise predictions, producing accurate segmentation masks 120.

The first computing device 102 may also determine object-aware semantic tokens 154 based on the feature tokens and the segmentation masks 120. Object-aware semantic tokens 154 may integrate information about the object's features and its spatial location within the image, enhancing the representation's specificity.

Using a rotation-aware encoder 156 model, the first computing device 102 may determine image-level embedding vectors representing rotation-aware features of the object based on the object-aware semantic tokens 154. The rotation-aware encoder 156 may be designed to produce embeddings that are sensitive to the object's orientation, enabling the system to distinguish between different poses. The rotation-aware encoder 156 may be developed and trained to produce embeddings that encapsulate the object's appearance across different orientations. Training the encoder may involve exposing it to images of the object in various poses and optimizing it to differentiate between them. Loss functions may be designed to penalize incorrect pose encoding, and techniques like data augmentation may be used to enhance robustness.

For example, when constructing the reference database 140 for a transparent bottle, the first computing device 102 may first select keyframes from the plurality of images 108 using farthest point sampling to ensure a diverse set of viewpoints is represented. Farthest point sampling selects images that are maximally different from each other in terms of camera position and orientation. The deep neural network 148 processes the images 108, including the key frames, to extract feature tokens representing visual characteristics of the bottle, such as its shape, transparency, and distinct features like labels or engravings. The feature tokens are then processed by the transformer-based module 150 and mask decoder 152 to generate accurate segmentation masks 120 for the bottle in each image 108. Combining the feature tokens and segmentation masks 120, the computing device 102 determines object-aware semantic tokens 154 that encapsulate both the appearance and spatial location of the bottle within the images 108. The rotation-aware encoder 156 processes these semantic tokens to produce image-level embedding vectors representing rotation-aware features of the bottle, capturing how it appears from different orientations. These embeddings, along with associated pose parameters 158, are stored in the reference database 140 as entries containing semantic representations 142 and rotation-aware encodings 144. This process results in a comprehensive reference database 140 that can be used to accurately identify the bottle and determine its pose in new images.

In certain implementations, the reference database 140 may be structured and stored as a collection of entries, each containing semantic representations 142, rotation-aware encodings 144, associated pose information, or a combination thereof. The database may be indexed for efficient retrieval, using data structures such as hash tables, KD-trees, or inverted files.

In certain implementations, the first computing device 102 may identify, for each respective image, a corresponding reference representation within the reference database 140. By matching the features extracted from the current image with those in the reference database 140, the device can determine the respective pose of the object in each respective image based on the corresponding reference representation. In certain implementations, the computing device 102 may utilize efficient retrieval and matching of reference representations, such as through nearest neighbor searches and similarity measures. In certain implementations, metrics such as cosine similarity or Euclidean distance may be used to compare feature vectors, while efficient algorithms like approximate nearest neighbor search may speed up the process.

In certain implementations, identifying the corresponding reference representation for each respective image may include extracting a semantic representation and rotation-aware features of the object from the respective image. These may be determined using techniques similar to those used to construct the reference database 140, discussed above. In certain implementations, the first computing device 102 may compare the extracted semantic representation and rotation-aware features with the reference database 140 to identify the corresponding reference representation. The comparison may use similarity metrics or distance measures such as cosine similarity, Euclidean distance, ad the like to quantify how closely the extracted features match those in the database.

Once the best match is identified, the first computing device 102 may determine an initial pose of the object in the respective image based on the corresponding reference representation. The initial pose may include estimates of the object's position and orientation derived from the matched reference entry.

Determining the respective pose may further include refining the initial pose by adjusting pose parameters to minimize a difference between a rendered projection of the second three-dimensional representation 130 and the respective image. In certain implementations, the first computing device 102 may render a projection of the 3D model from the estimated pose and compare it to the actual image. The difference may be quantified using loss functions such as pixel-wise differences, feature map differences, or silhouette comparisons. In certain implementations, one or more optimization techniques may be used for pose refinement, adjusting the pose parameters iteratively to reduce the difference. For example, techniques such as gradient descent or Levenberg-Marquardt may be employed to find the optimal pose that best aligns the projection with the image. Gradient descent updates the parameters in the direction of the negative gradient of the loss function, while Levenberg-Marquardt combines gradient descent and Gauss-Newton methods for efficient optimization.

By determining the pose of the object in each respective image using the methods described, the first computing device 102 enhances the accuracy and robustness of the 3D reconstruction process. Accurate pose estimation allows for proper alignment of the object across images, facilitates the integration of information from various viewpoints, and supports applications that require knowledge of the object's spatial orientation, such as robotic manipulation or augmented reality rendering.

In certain implementations, the first computing device 102 may further generate a depth map 174 of a scene including the object. A depth map 174 may refer to a two-dimensional image where each pixel represents the distance from the viewpoint (camera) to surfaces in the scene. In particular, the depth map 174 may be determined based on the images 108 captured by the computing device 102. In such instances, capturing the plurality of images 108 may include using a dual-camera module 104 to capture stereo image pairs. The dual-camera module 104 may consist of two cameras mounted at a fixed distance apart. The cameras may be aligned horizontally with parallel optical axes to ensure proper correspondence between images.

In certain implementations, the first computing device 102 may process the stereo image pairs using a third machine learning model to generate the depth map 174. Processing the stereo image pairs may include several steps, such as extracting features from the stereo image pairs, providing the features to the third machine learning model to perform recursive feature matching and depth estimation, and determining a refined depth map 174 representing both transparent and opaque materials present in the scene based on the depth estimation.

Extracting features from the stereo image pairs may involve detecting distinctive patterns or key points within the images that can be matched across the left and right views. The first computing device 102 may extract features at multiple downsampled scales to capture both global and local information. Multi-scale feature extraction may include processing the images at various resolutions by downsampling the original images to different scales. For example, the images may be downsampled by factors of 1 (original size), ½, ¼, and ⅛. Downsampling may be performed using interpolation methods such as bilinear or bicubic interpolation, and managed within the processing pipeline to ensure synchronization between the left and right images at each scale. The features extracted at each scale may include descriptors that encapsulate the appearance and spatial information of key points, facilitating accurate matching between the stereo images.

The third machine learning model may be a recurrent neural network (RNN) configured to perform recursive feature matching and/or depth estimation. In such instances, the third machine learning model may process the features extracted from the stereo image pairs by recursively matching features and updating depth estimates. At each iteration, the model may align features between the left and right images, compute disparity maps, and adjust depth predictions based on the discrepancies observed. The recursive nature of the model enables it to refine the depth map 174 by correcting errors and incorporating information from multiple scales and iterations.

Estimating depth for transparent materials poses significant challenges because traditional stereo matching relies on consistent appearance and correspondences between the left and right images. Transparent materials may refract light, causing distortions and inconsistencies that hinder accurate matching. The third machine learning model addresses these challenges by incorporating innovations that enable improved depth estimation accuracy for both transparent and opaque materials.

To address these difficulties, the third machine learning model may be trained using a synthetic dataset 176 comprising a plurality of randomly generated models, materials, lighting conditions, camera settings, and environmental effects. The synthetic dataset 176 may include materials such as solid, metallic, transparent, and fabric textures. Creating the synthetic dataset 176 involves generating 3D models with diverse geometries and applying various material properties to their surfaces.

Tools and software used for generation may include 3D modeling and rendering applications such as Blender, Autodesk Maya, or custom simulation engines. The dataset may encompass approximately 55,000 randomly generated models and 1,800 manually created materials, providing a wide range of scenarios for training. Lighting conditions may be varied using over 600 High Dynamic Range Images (HDRIs) to simulate indoor and outdoor environments with different illuminations and reflections. Camera settings may be adjusted to include various distances, angles, baselines, and configurations, ensuring that the model encounters a broad spectrum of perspectives during training.

The diversity in the synthetic dataset 176 contributes to the robustness of the third machine learning model by exposing it to numerous combinations of objects, materials, and conditions. This extensive variation enables the model to learn generalized representations and strategies for depth estimation that are applicable to real-world data. Training on transparent materials within the dataset helps the model develop the capability to handle the unique challenges posed by such objects.

Domain adaptation techniques may be used to bridge the gap between synthetic and real-world data. These techniques may include style transfer, where the synthetic images are transformed to resemble real images in terms of texture and noise characteristics. Alternatively, the model may be fine-tuned on a smaller set of real-world data after initial training on the synthetic dataset 176. This process helps the model adjust to discrepancies between synthetic and actual camera sensor responses, lighting variations, and other factors that differ between simulated and real environments.

By generating a refined depth map 174 representing both transparent and opaque materials present in the scene, the first computing device 102 enhances the depth information available for 3D reconstruction and scene understanding. The depth map 174 can be integrated with the segmentation masks 120 and 3D representations 126, 130 to produce more accurate and detailed models of the objects and their surroundings.

The inclusion of depth information complements the earlier steps of the method by providing an additional layer of spatial data that can improve feature alignment, handle occlusions, and aid in differentiating between objects at different distances. For example, in a scene where a transparent glass vase is placed in front of an opaque background, the depth map 174 can help distinguish the vase's contours and accurately model its position relative to other objects.

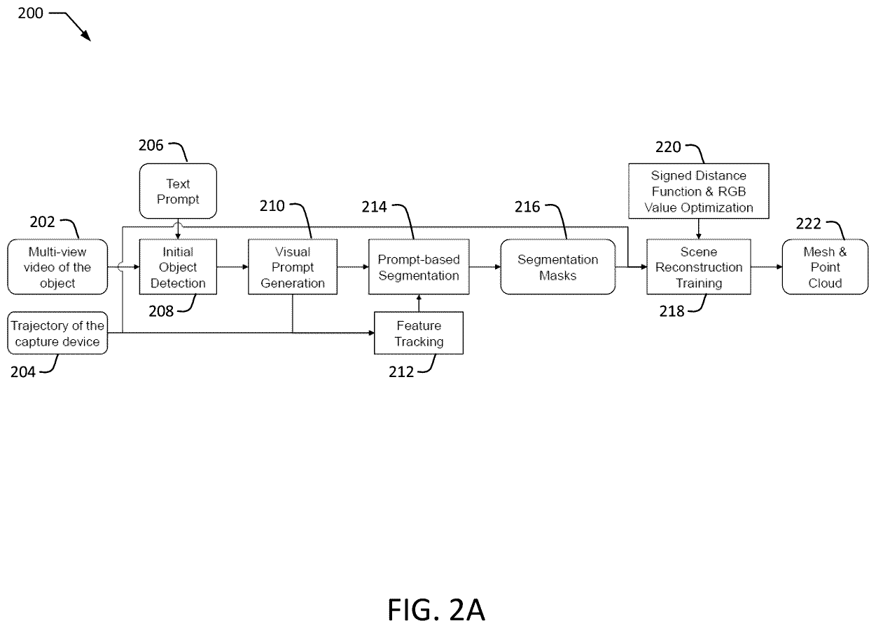

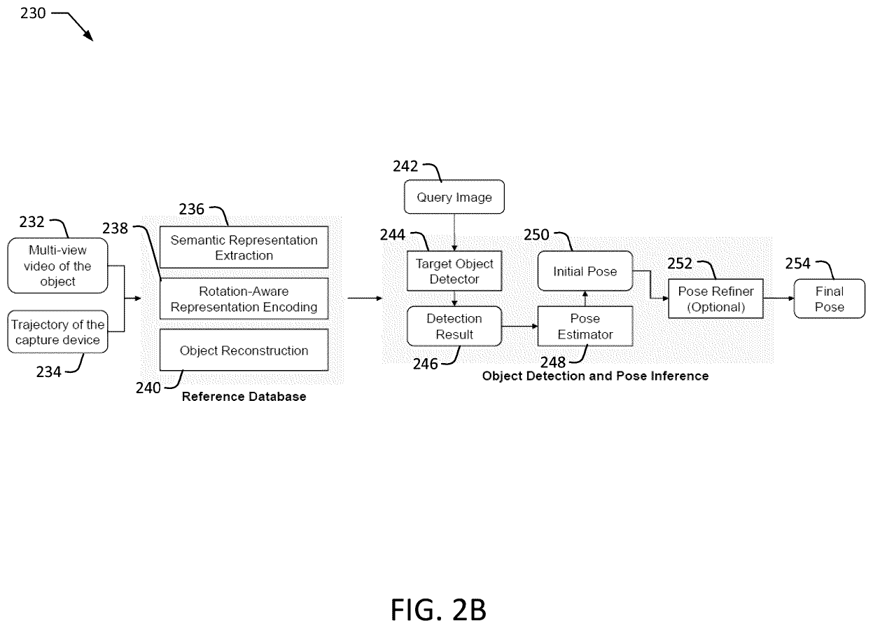

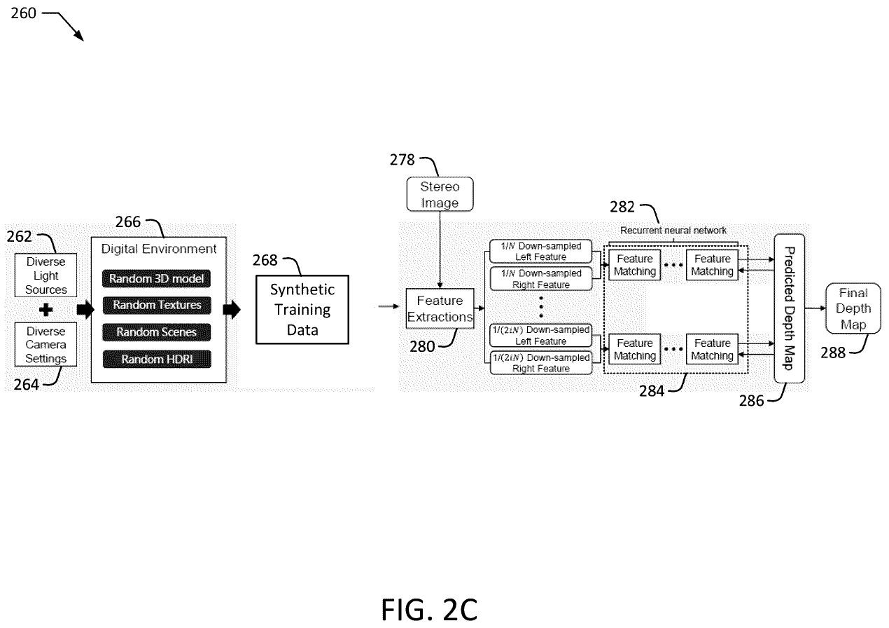

Additional, specific processing flows are provided in FIGS. 2A-2C. In particular, FIG. 2A shows a processing flow 200 for three-dimensional scanning according to one aspect of the present disclosure. In the processing flow 200, a multi-view video 202 of the target object may be captured to gather comprehensive image data from multiple angles. For example, the user may move a handheld computing device around the object, or place the object on a turntable while the device records the video. Alongside these image captures, trajectory data 204 may be recorded to track the position and orientation of the device as each video frame is captured. This trajectory data 204 can later assist in correlating visual features across frames.

Once the multi-view video 202 has been obtained, the system may receive a text prompt 206 from the user describing the object to be scanned. For instance, the prompt may indicate a transparent bottle or a particular color and shape. Based on this text prompt 206, the system performs an initial object detection 208 to locate bounding boxes around the specified object in each image frame. This initial detection 208 narrows down the search region for further processing.

Following the preliminary bounding-box detection, the system may carry out a visual prompt generation 210 to refine the segmentation task by identifying salient features in each bounding box. In some implementations, these visual prompts are derived from key points or distinctive visual cues that represent the object's unique attributes. Feature tracking 212 may then be employed to follow these prompts across consecutive frames, leveraging both the feature descriptors and the trajectory data 204 recorded during capture. Tracking helps maintain consistency of object detection, even as the viewpoint or lighting conditions change.

With the refined visual prompts in place, a prompt-based segmentation 214 step may be executed to generate segmentation masks 216 for each frame. In certain implementations, this segmentation harnesses a second machine learning model, which receives not only the bounding-box data from the user prompt but also the tracked visual features from the video. By combining textual guidance and visual cues, the model can produce segmentation results that tightly conform to the object's boundaries.

Once segmentation masks 216 have been established for each relevant frame, scene reconstruction training 218 may be initiated. This step often involves feeding the segmented images into a first machine learning model configured to learn volumetric or depth-based representations of the object. In some approaches, the method iterates through training epochs where the model refines its internal estimates of object geometry and color based on the segmentation data. The iterative process ultimately converges on an internal representation capable of mapping two-dimensional features to a cohesive three-dimensional shape.

In parallel or as part of the training process, the system may apply signed distance function and RGB value optimization 220, which refines the object's shape and color estimates. In certain implementations, a network learns to predict both geometry and appearance for each voxel or volumetric grid cell. Negative values may indicate locations inside the object, zero values on the surface, and positive values outside. The color component provides detailed texture information that aligns with the object's visual properties observed in the multi-view video 202.

When the training is complete, the system can generate a mesh and point cloud 222, which form the final three-dimensional representation of the object. The point cloud captures discrete points in three-dimensional space, while the mesh translates the volumetric representation or direct depth estimates into triangles or other polygons describing the object's surface. By combining geometry from the signed distance function with the learned color (RGB) values, the result is often a high-fidelity reconstruction that captures both the shape and appearance of the scanned object.

In summary, the processing flow 200 combines text-driven object localization, tracked visual features, and learned volumetric reconstruction into a cohesive pipeline. From the multi-view video 202 and device trajectory 204 at the front end, to the refined mesh and point cloud 222 at the conclusion, each block in the workflow supports a portion of the scanning process. This integrated approach is particularly effective for complex or transparent objects, as it leverages user-provided cues and advanced modeling to yield accurate three-dimensional renders.

FIG. 2B shows a processing flow 230 for pose estimation according to one aspect of the present disclosure. The processing flow 230 begins with multi-view video 232 of an object being captured, along with trajectory data 234 of the capture device. The purpose of collecting both the video and trajectory data 234 is to build a robust dataset that helps form a reference database for pose estimation. For instance, if the object is a transparent bottle, multiple viewpoints and the device's motion path can ensure that enough distinct features and perspectives are available for subsequent reconstruction and pose analysis.

Once these data are gathered, the system may conduct semantic representation extraction 236. During semantic representation extraction 236, the system processes frames from the video 232 to identify key visual attributes of the object—an approach that may include detecting corners, edges, or distinctive surface textures. Filtering these attributes through a neural network can yield high-level semantic information that describes how the object generally appears under varying lighting conditions and angles.

Subsequently, rotation-aware representation encoding 238 may embed the object's appearance into orientation-sensitive feature vectors. Although semantic representation extraction 236 typically focuses on keyframes to capture high-level features comprehensively, rotation-aware representation encoding 238 may operate on all frames to generate orientation-specific encodings. In some implementations, these steps remain largely independent—semantic representation extraction 236 provides coarse features for keyframes while rotation-aware encoding 238 analyzes the broader dataset of frames to account for changes in viewpoint or object orientation.

Following the rotation-aware encoding 238, object reconstruction 240 may be performed to build a consistent 3D representation from the collected frames. The reconstruction 240 component can integrate the semantic information and orientation cues, producing an approximate or rough 3D model. This rough model or dataset becomes a central part of the reference database, enabling the system to match future query images against known objects stored within the database.

When an image (query image 242) is later presented for pose estimation, the target object detector 244 compares the query image 242 to stored semantic and rotation-aware representations. The detection result 246 indicates whether the object of interest is present in the image and, if so, provides an approximate location or bounding box. Next, a pose estimator 248 delivers an initial pose 250 by aligning the detected object in the query image 242 to a corresponding model in the reference database.

In certain implementations, an optional pose refiner 252 can further refine the initial pose 250 to enhance accuracy. This step might use optimization algorithms that minimize the difference between a rendered projection of the 3D model and the actual visual data in the query image 242.

Finally, the system provides a final pose 254, which encapsulates the updated position and orientation of the recognized object. With the final pose 254 in hand, downstream processes—such as rendering, scene analysis, or manipulation tasks—can be performed. This structured flow of extracting semantic features, building a rotation-aware reference database, detecting the object in query images, and refining its pose allows robust, real-time pose estimation that can handle challenging objects, including transparent and multi-textured surfaces.

FIG. 2C shows a processing flow 260 for depth map determination according to one aspect of the present disclosure. The processing flow 260 begins with generating a digital environment 266, which is designed to create a broad range of training scenarios for depth estimation. The digital environment 266 may include diverse light sources 262 and diverse camera settings 264 that mimic real-world capture conditions. By incorporating various lighting intensities, angles, and color profiles, the system can ensure robust performance. Similarly, the camera parameters (e.g., focal length, baseline distance, image resolution) may be varied to produce synthetic images that reflect a wide array of practical capture scenarios.

Within the digital environment 266, multiple random 3D models, random textures, random scenes, and random high dynamic range images (HDRI) may be generated or combined to approximate realistic scenes. Random 3D models may refer to objects of varying geometry and complexity, such as organic shapes, mechanical parts, or household items. In certain cases, random textures may involve both opaque and transparent materials to train the model in challenging scenarios. Random scenes can combine these objects and textures within different backgrounds or layouts, while random HDRI helps simulate complex lighting conditions, including indoor and outdoor setups.

After constructing these environments, the system can render synthetic training data 268. Synthetic training data 268 refers to a dataset of stereo image pairs and corresponding ground-truth depth information obtained directly from the rendering pipeline. This approach allows the depth prediction model to observe a wide variety of object shapes, surface properties, transparency levels, and spatial configurations. By training on an extensive range of appearances, the model gains better generalization capability when processing real-world images.

Once the depth prediction model is trained or adapted using this synthetic dataset, a stereo image 278 from the real environment may be captured. In such scenarios, the stereo image 278 typically consists of a left view and a right view of the same scene. The next step is feature extractions 280, where distinct visual features (e.g., edges, corners) are identified and encoded. These features help the system match corresponding content between the left and right images.

The core processing relies on a recurrent neural network 282 that iteratively refines its depth estimation. At each stage, feature matching 284 may be performed across multi-scale or downsampled representations of the stereo pair. The recurrent neural network 282 uses these matching results, along with predicted depth information, to progressively improve the depth map. After several iterations, the network produces a predicted depth map 286 indicating distances to objects or surfaces in the scene.

In certain implementations, the predicted depth map 286 undergoes further refinement to address edge cases such as low-textured regions, reflective areas, or transparent objects. Techniques like confidence modeling or multi-scale post-processing may help clean up anomalies. Ultimately, this produces a final depth map 288 that captures both opaque and transparent surfaces with robust accuracy. The final depth map 288 can be integrated into higher-level functions including 3D scanning, mixed reality overlays, or robotic manipulation tasks.

This iterative, feature-driven approach helps ensure that subtle details are captured in the final depth map 288, while scaling effectively to diverse materials and lighting conditions. By leveraging a synthetic training pipeline and real stereo images, the system unites data-driven depth estimation with flexible, high-coverage training scenarios. Consequently, processing flow 260 is well-suited for advanced surface reconstruction projects that require detailed depth information even in the presence of transparent or reflective objects.

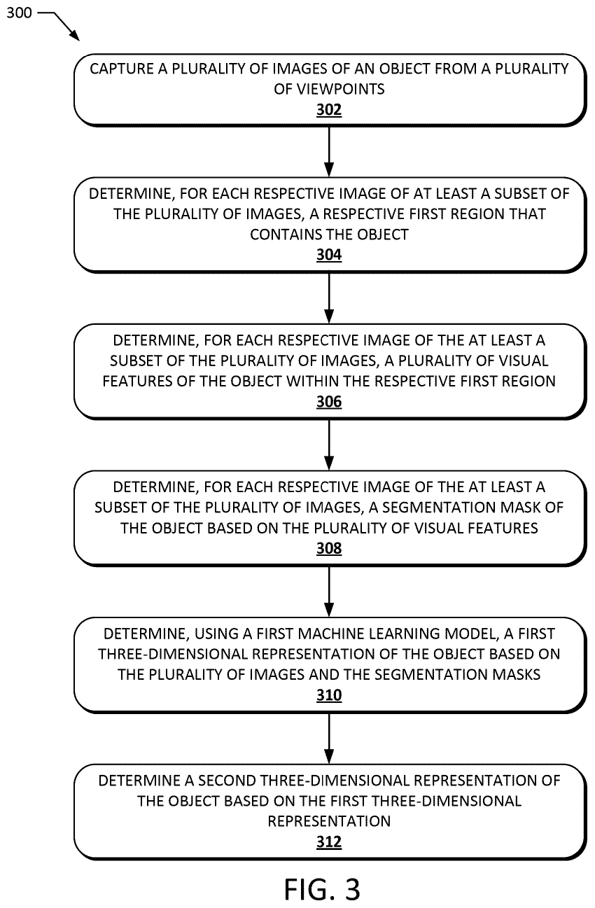

FIG. 3 depicts a method 300 for image-based three-dimensional sensing according to one aspect of the present disclosure. The method 300 may be implemented on a computer system, such as the system 100. For example, the method 300 may be implemented by the computing device 102. The method 300 may also be implemented by a set of instructions stored on a computer readable medium that, when executed by a processor, cause the computing device to perform the method 300. Although the examples below are described with reference to the flowchart illustrated in FIG. 3, many other methods of performing the acts associated with FIG. 3 may be used. For example, the order of some of the blocks may be changed, certain blocks may be combined with other blocks, one or more of the blocks may be repeated, and some of the blocks may be optional.

At block 302, the method 300 includes capturing, by a first computing device, a plurality of images of an object from a plurality of viewpoints. For example, the computing device 102 may capture a plurality of images 108 of an object from various viewpoints. In certain implementations, capturing the plurality of images may comprise extracting the images from a video captured by the computing device 102 that contains the object. The video may capture views covering approximately 360 degrees around the object, excluding a bottom surface of the object. In some cases, the computing device 102 may be a consumer device selected from the group consisting of a smartphone and a tablet. Additionally, the object may include at least a transparent material.

At block 304, the method 300 includes determining, for each respective image of at least a subset of the plurality of images, a respective first region that contains the object. For example, the computing device 102 may determine, for each image of at least a subset of the images 108, a respective first region that contains the object. In certain implementations, determining the respective first region of each image may involve determining a bounding box around the object in each respective image based on a text input received from a user. The text input may specify one or more characteristics of the object. The computing device 102 may apply an object detection model 112 configured to detect objects corresponding to the text input within the images 108.

At block 306, the method 300 includes determining, for each respective image of the at least a subset of the plurality of images, a plurality of visual features of the object within the respective first region. For example, the computing device 102 may determine, for each image of the images 108, a plurality of visual features 116 of the object within the respective first region. In certain implementations, the plurality of visual features may be estimated key points of the object within the respective first region.

At block 308, the method 300 includes determining, for each respective image of the at least a subset of the plurality of images, a segmentation mask of the object based on the plurality of visual features. For example, the computing device 102 may determine, for each image of the images 108, a segmentation mask 120 of the object based on the visual features 116. In certain implementations, generating the segmentation mask of the object may involve using a second machine learning model configured for prompt-based segmentation.

At block 310, the method 300 includes determining, using a first machine learning model, a first three-dimensional representation of the object based on the plurality of images and the segmentation masks. For example, the computing device 102 may determine, using a first machine learning model 122, a first three-dimensional representation 126 of the object based on the images 108 and the segmentation masks 120. In certain implementations, the method 300 may further include training the first machine learning model based on the plurality of images and the segmentation masks. In some cases, the first machine learning model 122 may be configured to determine signed distance function values and red-green-blue (RGB) color values based on the images 108 and the segmentation masks 120. Additionally, the first machine learning model 122 may be a neural network.

At block 312, the method 300 includes determining a second three-dimensional representation of the object based on the first three-dimensional representation. For example, the computing device 102 may determine a second three-dimensional representation 130 of the object based on the first three-dimensional representation 126. In certain implementations, the first three-dimensional representation 126 may include one or more parameters representing estimated volumetric data of the object, and the second three-dimensional representation 130 may include a plurality of three-dimensional coordinates defining a surface of the object. In some cases, generating the second three-dimensional representation 130 may involve converting the signed distance function values and RGB color values into a three-dimensional point cloud and mesh model.

In certain implementations, the method 300 may further include determining, for each respective image of the at least a subset of the plurality of images, a respective pose of the object in the respective image. For example, the computing device 102 may determine, for each image of the images 108, a respective pose of the object in that image. In certain implementations, determining the respective pose of the object may involve constructing a reference database 140 for the object based on the plurality of images 108. The reference database 140 may comprise semantic representations 142 of the object, rotation-aware encodings 144 of the object, or a combination thereof. The computing device 102 may identify, for each respective image, a corresponding reference representation within the reference database 140, and determine the respective pose of the object in each image based on the corresponding reference representation.

In certain implementations, the method 300 may include constructing the reference database 140 by selecting, using farthest point sampling, one or more keyframes from the plurality of images 108. For example, the computing device 102 may determine, using a deep neural network 148, feature tokens from the one or more keyframes. The feature tokens may be processed with a transformer-based module 150 and a mask decoder 152 to generate segmentation masks 120 for the object based on the feature tokens. The computing device 102 may determine object-aware semantic tokens 154 based on the feature tokens and the segmentation masks 120. Using a rotation-aware encoder model 156, the computing device 102 may determine image-level embedding vectors representing rotation-aware features of the object based on the object-aware semantic tokens 154.

In certain implementations, the method 300 may include identifying the corresponding reference representation for each respective image. For example, the computing device 102 may extract a semantic representation and rotation-aware features of the object from each respective image. The extracted semantic representation and rotation-aware features may be compared with the reference database 140 to identify the corresponding reference representation. The computing device 102 may determine an initial pose of the object in each respective image based on the corresponding reference representation.

In certain implementations, the method 300 may include refining the initial pose by adjusting pose parameters to minimize a difference between a rendered projection of the second three-dimensional representation and the respective image. For example, the computing device 102 may refine the pose by adjusting the pose parameters iteratively to reduce the difference.

In certain implementations, the method 300 may include extracting the semantic representation and rotation-aware features from the respective image. For example, the computing device 102 may apply a deep neural network 148 to the respective image to extract feature tokens. The feature tokens may be processed with a transformer-based module 150 and a mask decoder 152 to generate a segmentation mask 120 for the object in the respective image. The computing device 102 may determine object-aware semantic tokens 154 based on the feature tokens and the segmentation mask 120, and process the object-aware semantic tokens 154 using a rotation-aware encoder 156 to produce image-level embedding vectors representing rotation-aware features of the object.

In certain implementations, the method 300 may further include generating a depth map of a scene including the object. For example, the computing device 102 may generate a depth map 174 of the scene based on the images 108. In certain implementations, capturing the plurality of images may comprise using a dual-camera module 104 to capture stereo image pairs.

In certain implementations, the method 300 may include processing the stereo image pairs using a third machine learning model to generate the depth map 174. For example, the computing device 102 may extract features from the stereo image pairs and provide the features to the third machine learning model to perform recursive feature matching and depth estimation. The computing device 102 may determine a refined depth map 174 representing both transparent and opaque materials present in the scene based on the depth estimation.

In certain implementations, extracting features from the stereo image pairs may involve extracting features at multiple downsampled scales. The third machine learning model may be a recurrent neural network. In some cases, the third machine learning model may be trained using a synthetic dataset 176 comprising a plurality of randomly generated models, materials, lighting conditions, camera settings, and environmental effects. The materials in the synthetic dataset 176 may include solid, metallic, transparent, and fabric textures.

In certain implementations, the method 300 may further include correlating the plurality of visual features across the at least a subset of the plurality of images to identify corresponding features. For example, the computing device 102 may correlate the visual features 116 across the images 108 to identify corresponding features. Capturing the plurality of images may further comprise recording trajectory data 134 corresponding to each image, the trajectory data indicating a position and/or an orientation of the computing device 102 when capturing each respective image. Correlating the plurality of visual features may be performed at least in part based on the trajectory data 134.

In certain implementations, the method 300 may further handle multiple objects by repeating the determining and generating steps for each object individually. For example, the computing device 102 may detect and process multiple objects within the images 108 by applying the method 300 sequentially or in parallel for each object.

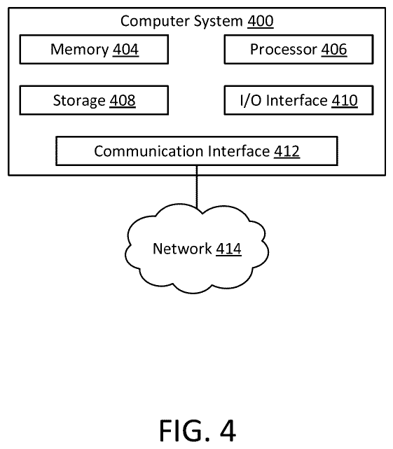

FIG. 4 illustrates an example computer system 400 that may be utilized to implement one or more of the devices and/or components discussed herein, such as the computing device 102. In particular implementations, one or more computer systems 400 perform one or more steps of the methods described or illustrated herein, such as the method 300. In certain implementations, one or more computer systems 400 provide the functionalities described or illustrated herein, such as capturing images, processing visual features, and generating three-dimensional representations. In certain implementations, software running on one or more computer systems 400 performs one or more steps of the methods described or illustrated herein or provides the functionalities described or illustrated herein. Particular implementations include one or more portions of one or more computer systems 400. Herein, a reference to a computer system may encompass a computing device, and vice versa, where appropriate. Moreover, a reference to a computer system may encompass one or more computer systems, where appropriate.

This disclosure contemplates any suitable number of computer systems 400. This disclosure contemplates the computer system 400 taking any suitable physical form. As an example and not by way of limitation, the computer system 400 may be an embedded computer system, a system-on-chip (SoC), a single-board computer system (SBC) (such as, for example, a computer-on-module (COM) or system-on-module (SOM)), a desktop computer system, a laptop or notebook computer system, a mobile telephone, a tablet computer system, a consumer device equipped with a camera module 104, or a combination of two or more of these. Where appropriate, the computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular implementations, computer system 400 includes a processor 406, memory 404, storage 408, an input/output (I/O) interface 410, sensors 414, and a communication interface 412. Although this disclosure describes and illustrates a particular computer system having a particular number of particular components in a particular arrangement, this disclosure contemplates any suitable computer system having any suitable number of any suitable components in any suitable arrangement.

In particular implementations, the processor 406 includes hardware for executing instructions, such as those making up a computer program. For example, the processor 406 may execute instructions to perform image processing, feature detection, machine learning model inference, and three-dimensional reconstruction as described herein. As an example and not by way of limitation, to execute instructions, the processor 406 may retrieve (or fetch) the instructions from an internal register, an internal cache, memory 404, or storage 408; decode and execute the instructions; and then write one or more results to an internal register, internal cache, memory 404, or storage 408. In particular implementations, the processor 406 may include one or more internal caches for data, instructions, or addresses. This disclosure contemplates the processor 406 including any suitable number of any suitable internal caches, where appropriate. As an example and not by way of limitation, the processor 406 may include one or more instruction caches, one or more data caches, and one or more translation lookaside buffers (TLBs). Instructions in the instruction caches may be copies of instructions in memory 404 or storage 408, and the instruction caches may speed up retrieval of those instructions by the processor 406. Data in the data caches may be copies of data in memory 404 or storage 408 that are to be operated on by computer instructions; the results of previous instructions executed by the processor 406 that are accessible to subsequent instructions or for writing to memory 404 or storage 408; or any other suitable data. The data caches may speed up read or write operations by the processor 406. The TLBs may speed up virtual-address translation for the processor 406. In particular implementations, processor 406 may include one or more internal registers for data, instructions, or addresses. This disclosure contemplates the processor 406 including any suitable number of any suitable internal registers, where appropriate. Where appropriate, the processor 406 may include one or more arithmetic logic units (ALUs), be a multi-core processor, or include one or more processors 406. Although this disclosure describes and illustrates a particular processor, this disclosure contemplates any suitable processor.

In particular implementations, the memory 404 includes main memory for storing instructions for the processor 406 to execute or data for processor 406 to operate on. The memory 404 may store software modules implementing functionalities such as the object detection model 112, the first machine learning model 122, the second machine learning model for prompt-based segmentation, and the third machine learning model for depth estimation. Additionally, the memory 404 may store data such as the images 108, visual features 116, segmentation masks 120, and three-dimensional representations 126, 130. As an example, and not by way of limitation, computer system 400 may load instructions from storage 408 or another source (such as another computer system 400) to the memory 404. The processor 406 may then load the instructions from the memory 404 to an internal register or internal cache. To execute the instructions, the processor 406 may retrieve the instructions from the internal register or internal cache and decode them. During or after execution of the instructions, the processor 406 may write one or more results (which may be intermediate or final results) to the internal register or internal cache. The processor 406 may then write one or more of those results to the memory 404. In particular implementations, the processor 406 executes only instructions in one or more internal registers or internal caches or in memory 404 (as opposed to storage 408 or elsewhere) and operates only on data in one or more internal registers or internal caches or in memory 404 (as opposed to storage 408 or elsewhere). One or more memory buses (which may each include an address bus and a data bus) may couple the processor 406 to the memory 404. The bus may include one or more memory buses, as described in further detail below. In particular implementations, one or more memory management units (MMUs) reside between the processor 406 and memory 404 and facilitate accesses to the memory 404 requested by the processor 406. In particular implementations, the memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory implementations, this disclosure contemplates any suitable memory implementation.

In particular implementations, the storage 408 includes mass storage for data or instructions. The storage 408 may store datasets used for training the machine learning models, such as the synthetic dataset 176 comprising a plurality of randomly generated models, materials, lighting conditions, camera settings, and environmental effects. Additionally, the storage 408 may store the reference database 140 containing semantic representations 142 and rotation-aware encodings 144 of objects. As an example and not by way of limitation, the storage 408 may include a hard disk drive (HDD), a floppy disk drive, flash memory, an optical disc, a magneto-optical disc, magnetic tape, or a Universal Serial Bus (USB) drive or a combination of two or more of these. The storage 408 may include removable or non-removable (or fixed) media, where appropriate. The storage 408 may be internal or external to computer system 400, where appropriate. In particular implementations, the storage 408 is non-volatile, solid-state memory. In particular implementations, the storage 408 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 408 taking any suitable physical form. The storage 408 may include one or more storage control units facilitating communication between processor 406 and storage 408, where appropriate. Where appropriate, the storage 408 may include one or more storages 408. Although this disclosure describes and illustrates particular storage, this disclosure contemplates any suitable storage.

In particular implementations, the I/O interface 410 includes hardware, software, or both, providing one or more interfaces for communication between computer system 400 and one or more I/O devices. The I/O devices may include a camera module 104 for capturing images 108, input devices for receiving text input 138, and output devices for displaying prompts or results. Additionally, the I/O interface 410 may interface with sensors 414, such as gyroscopes and accelerometers, which provide trajectory data 134. The computer system 400 may include one or more of these I/O devices, where appropriate. One or more of these I/O devices may enable communication between a person (i.e., a user) and computer system 400. As an example and not by way of limitation, an I/O device may include a keyboard, keypad, microphone, monitor, screen, display panel, mouse, touchscreen, or another suitable I/O device or a combination of two or more of these. Where appropriate, the I/O interface 410 may include one or more device or software drivers enabling processor 406 to drive one or more of these I/O devices. The I/O interface 410 may include one or more I/O interfaces 410, where appropriate. Although this disclosure describes and illustrates a particular I/O interface, this disclosure contemplates any suitable I/O interface or combination of I/O interfaces.

In particular implementations, sensors 414 include hardware for detecting movement and orientation of the computing device 102. These sensors may include gyroscopes, accelerometers, magnetometers, or other motion sensors. The sensors 414 provide trajectory data 134, indicating the position and/or orientation of the computing device 102 when capturing each respective image 108. This data is utilized in methods such as correlating visual features and enhancing feature matching accuracy.

In particular implementations, communication interface 412 includes hardware, software, or both providing one or more interfaces for communication (such as, for example, packet-based communication) between computer system 400 and one or more other computer systems 400 or one or more networks. As an example and not by way of limitation, communication interface 412 may include a network interface controller (NIC) or network adapter for communicating with an Ethernet or any other wire-based network or a wireless NIC (WNIC) or wireless adapter for communicating with a wireless network, such as a Wi-Fi network. Communication interface 412 may enable the computing device 102 to connect to cloud services or external databases for additional processing power, data storage, or model updates. This disclosure contemplates any suitable network and any suitable communication interface 412 for the network. As an example and not by way of limitation, the network may include one or more of an ad hoc network, a personal area network (PAN), a local area network (LAN), a wide area network (WAN), or one or more portions of the Internet or a combination of two or more of these. One or more portions of one or more of these networks may be wired or wireless. As an example, computer system 400 may communicate with a wireless PAN (WPAN) (such as, for example, a Bluetooth® WPAN), a Wi-Fi network, a cellular telephone network, or any other suitable wireless network or a combination of two or more of these. Computer system 400 may include any suitable communication interface 412 for any of these networks, where appropriate. Communication interface 412 may include one or more communication interfaces 412, where appropriate. Although this disclosure describes and illustrates particular communication interface implementations, this disclosure contemplates any suitable communication interface implementation.

The computer system 400 may also include a bus 402. The bus 402 may include hardware, software, or both and may communicatively couple the components of the computer system 400 to each other. As an example and not by way of limitation, the bus 402 may include an Accelerated Graphics Port (AGP) or any other graphics bus, an Enhanced Industry Standard Architecture (EISA) bus, a front-side bus (FSB), an Industry Standard Architecture (ISA) bus, a Peripheral Component Interconnect (PCI) bus, a PCI-Express (PCIe) bus, or another suitable bus or a combination of two or more of these buses. The bus 402 facilitates communication between the processor 406, memory 404, storage 408, I/O interface 410, communication interface 412, and sensors 414. The bus 402 may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), solid-state drives (SSDs), RAM-drives, Secure Digital cards or drives, any other suitable computer-readable non-transitory storage media, or any suitable combination of two or more of these, where appropriate. The storage medium may store instructions executable by the processor 406 to perform the methods described herein, such as capturing images, processing visual features, executing machine learning models, and generating three-dimensional representations. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example implementations described or illustrated herein that a person having ordinary skill in the art would comprehend. The scope of this disclosure is not limited to the example implementations described or illustrated herein. Moreover, although this disclosure describes and illustrates specific implementations as including particular components, elements, features, functions, operations, or steps, any of these implementations may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Additionally, although this disclosure describes or illustrates specific implementations as providing particular advantages, particular implementations may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
capturing, by a first computing device, a plurality of images of an object from a plurality of viewpoints;
determining, for each respective image of at least a subset of the plurality of images, a respective first region that contains the object;
determining, for each respective image of the at least a subset of the plurality of images, a plurality of visual features of the object within the respective first region;
determining, for each respective image of the at least a subset of the plurality of images, a segmentation mask of the object based on the plurality of visual features;
determining, using a first machine learning model, a first three-dimensional representation of the object based on the plurality of images and the segmentation masks; and
determining a second three-dimensional representation of the object based on the first three-dimensional representation.

2. The method of claim 1, further comprising training the first machine learning model based on the plurality of images and the segmentation masks prior to determining the first three-dimensional representation.

3. The method of claim 1, wherein the first three-dimensional representation comprises one or more parameters representing estimated volumetric data of the object, the second three-dimensional representation comprises a plurality of three-dimensional coordinates defining a surface of the object, or a combination thereof.

4. The method of claim 1, wherein the first machine learning model is configured to determine signed distance function values and red-green-blue (RGB) color values based on the plurality of images and the segmentation masks.

5. The method of claim 4, wherein generating the second three-dimensional representation comprises converting the signed distance function values and RGB color values into a three-dimensional point cloud and mesh model.

6. The method of claim 1, wherein capturing the plurality of images comprises extracting the plurality of images from a video captured by the first computing device that contains the object.

7. The method of claim 1, wherein determining the respective first region of each respective image comprises determining a bounding box around the object in each respective image based on a text input received from a user.

8. The method of claim 7, wherein the text input specifies one or more characteristics of the object.

9. The method of claim 7, wherein determining the bounding box around the object comprises applying an object detection model configured to detect objects corresponding to the text input within the plurality of images.

10. The method of claim 1, further comprising correlating the plurality of visual features across the at least a subset of the plurality of images to identify corresponding features.

11. The method of claim 10, wherein capturing the plurality of images further comprises recording trajectory data corresponding to each image, the trajectory data indicating a position and/or an orientation of the first computing device when capturing the respective image, wherein correlating the plurality of visual features is performed at least in part based on the trajectory data.

12. The method of claim 1, wherein the object comprises at least a transparent material.

13. The method of claim 1, further comprising determining, for each respective image of the at least a subset of the plurality of images, a respective pose of the object in the respective image.

14. The method of claim 13, wherein determining the respective pose of the object comprises:
constructing a reference database for the object based on the plurality of images, wherein the reference database comprises semantic representations of the object, rotation-aware encodings of the object, or a combination thereof;
identifying, for each respective image, a corresponding reference representation within the reference database; and
determining the respective pose of the object in each respective image based on the corresponding reference representation.

15. The method of claim 14, wherein constructing the reference database further comprises:
selecting, using farthest point sampling, one or more keyframes from the plurality of images;
determining, using a deep neural network, feature tokens from the one or more keyframes;
determining, using a transformer-based module and a mask decoder, segmentation masks for the object based on the feature tokens;
determining object-aware semantic tokens based on the feature tokens and the segmentation masks; and
determining, using a rotation-aware encoder model, image-level embedding vectors representing rotation-aware features of the object based on the object-aware semantic tokens.

16. The method of claim 15, wherein identifying the corresponding reference representation for each respective image comprises:
extracting a semantic representation and rotation-aware features of the object from the respective image;
comparing the extracted semantic representation and rotation-aware features with the reference database to identify the corresponding reference representation; and
determining an initial pose of the object in the respective image based on the corresponding reference representation.

17. The method of claim 1, wherein capturing the plurality of images comprises using a dual-camera module to capture stereo image pairs.

18. The method of claim 17, further comprising:
processing the stereo image pairs using a third machine learning model to generate a depth map, wherein processing the stereo image pairs comprises:
extracting features from the stereo image pairs;
providing the features to the third machine learning model to perform recursive feature matching and depth estimation; and
determining a refined depth map representing both transparent and opaque materials present in the scene based on the depth estimation.

19. The method of claim 18, wherein the third machine learning model is trained using a synthetic dataset comprising a plurality of randomly generated models, materials, lighting conditions, camera settings, and environmental effects.

20. A system comprising:
a processor; and
a memory storing instructions which, when executed by the processor, cause the processor to perform operations including:
capturing a plurality of images of an object from a plurality of viewpoints;
determining, for each respective image of at least a subset of the plurality of images, a respective first region that contains the object;
determining, for each respective image of the at least a subset of the plurality of images, a plurality of visual features of the object within the respective first region;
determining, for each respective image of the at least a subset of the plurality of images, a segmentation mask of the object based on the plurality of visual features;
determining, using a first machine learning model, a first three-dimensional representation of the object based on the plurality of images and the segmentation masks; and
determining a second three-dimensional representation of the object based on the first three-dimensional representation.
